(19) United States
(12) Patent Application Publication
(10) Pub. No.: US 2002/0178607 A1
(43) Pub. Date: Dec. 5, 2002

(54) Method for making expanded clay pieces and resulting pieces

(75) Inventors: Frederic Vandenbussche, Marseille (FR); Nathalie Bessiron, Marseille (FR)

Correspondence Address: GREENBLUM & BERNSTEIN, P.L.C., 1941 ROLAND CLARKE PLACE, RESTON, VA, 20191, US

(73) Assignee: ENTEMA (SARL), Marseille (FR)

(21) Appl. No.: 10/141,002

(22) Filed: May 9, 2002

Related U.S. Application Data
(63) Continuation-in-part of application No. PCT/FR00/03034, filed on Oct. 31, 2000.

(30) Foreign Application Priority Data
Nov. 10, 1999 (FR) 99/14398

(51) Int. Cl. F26B 3/34

(52) U.S. Cl. 34/259

(57) ABSTRACT

The invention concerns a method for making expanded clay granules, characterized in that the granules are expanded by being heated with microwave radiation.

### CROSS REFERENCE TO RELATED APPLICATIONS

The instant application is a continuation-in-part of PCT International Application PCT/FR00/03034, which was not published in English under PCT Article 21(2), the disclosure of which is hereby expressly incorporated by reference in its entirety. The instant application claims priority to Frecnch Patent Application No. 99/14398, filed Nov. 10, 1999, the disclosure of which is hereby expressly incorporated by reference in its entirety.

### BACKGROUND OF THE INVENTION

1. Field of the Invention

The present invention relates to a new method for making expanded clay pieces, and to pieces such as granules, bricks, slabs, sections, obtained from this method.

2. Background and Material Information

Expanded clay has been used in the form of light aggregates for a number of years, in civil engineering and building activities, particularly for lightening concrete. This material offers numerous advantages: it is natural, solid, insulating, uniform, incombustible, easy to use, stable, chemically inert, rot-proof, and economical. In view of these numerous qualities, it is also widely used in other fields, such as thermal insulation, decoration, gardening, aquaculture, incineration, landscaping, compost preparation, filtration, antipollution, fish breeding, etc.

The discovery of expanded clay dates back to around 1885; however, it was not until 1917 that the first plant for manufacturing this material, using a rotary furnace as the expansion furnace, was built by S J HAYDE.

The expansion is carried out at a temperature of about 1100° C. by a sudden gas evolution within a plastic mass of clay which causes the creation of micro gas pockets.

The expanded clay balls or granules obtained have a vitrified shell, and are very hard and very light; their density is about 300-630 kg/m³.

The technique for manufacturing them has not changed substantially since the implementation of the first curing and expansion furnaces; this manufacture is still carried out by high-temperature heating in rotary furnaces. The heat energy is created by the combustion of a combustible such as gas or fuel.

Several steps are necessary to obtain expanded balls or granules:

1. preparing the clay under precise and perfectly controlled technical conditions (grinding, laminating, humidification) in order to make the granules (granulation);

2. mixing with one or more additives, such as fuel, for example, if necessary;

3. drying and storing the granules;

4. curing the latter in a first rotary furnace;

5. passing the cured clay granules in a second rotary furnace brought to 1100° C. and carefully controlled; a gas evolution causes the creation of cells and, therefore, the expansion of the clay granules within the mass of clay rendered plastic by the high temperature;

6. cooling the granules by passage in a cooling tunnel.

Finally, the granules, which have become substantially spherical, are screened and distributed in concrete-reinforced storage bins, in order to avoid smears and mixtures of different qualities.

However, this technique for making expanded clay granules has several disadvantages:

the infrastructures used are very heavy if one considers that they include two or three furnaces arranged in line or in cascade connection between the input of the dried clay granules and the output of the expanded granules toward a screening and storing station. Furthermore, these infrastructures entail high operating and maintenance costs, due in particular to the fact that they comprise mechanical parts that are subject to high temperatures;

the efficiency of these plants is low. Since clay is a refractory material, a large amount of the heating energy is lost. Moreover, the current heating method and installations heat the material from the outside inward. This poor distribution of heat energy leads to an overconsumption of energy and the creation of thermal stresses in the material, which can cause the clay granules or balls to burst and, consequently, a decrease in productivity.

Furthermore, this manufacturing technique does not make it possible to make large expanded clay pieces (slabs, panels, sections, etc.), or non-spherical or approximately spherical pieces (sections, curbstones, panels, etc.).

These furnaces also generate harmful effects for the environment (sound, atmospheric and visual pollution) due to their inadequate soundproofing and emanations (smoke). They can also present a danger for their immediate environment (personnel and visitors) in the case of poor acoustic insulation or defective thermal insulation. Furthermore, they require storage of combustibles.

long furnace heating times;

difficult control.

It must also be noted that depending on the exposure of the granules relative to the burners of the rotary heating furnaces, their expansion is more or less complete, such that the efficiency of this manufacturing technique is uncertain, and the qualities of the expanded clay granules obtained are highly variable and difficult to control.

Document FR-2.101.602A describes a method for the expansion of vermiculite, which consists of irradiating the latter with an electromagnetic wave having a frequency comprised between 1 megacycle per second and 10,000 megacycles per second, especially for applications to heat insulating or packing materials. However, the low mechanical properties of the expanded vermiculite do not permit its use in applications, such as the manufacture of light concretes in construction, which require properties of high mechanical strength. In addition, the methods for the expansion of the vermiculite and clay are different. For vermiculite, the expansion is due solely to the vaporization of the interfoliaceous water which causes the separation of the sheets constituting the material, which acquires its characteristic accordion-like shape or vermicular markings.

The method for the expansion of clay is different: bringing the clay to high temperatures causes gas evolutions within the clay matrix, which result in the appearance of millimetric pores within the thermoplastic material.

These gas evolutions are produced by a plurality of chemical reactions:

decomposition of secondary minerals (sulfates, sulfide, etc.);

combustion of organic materials (carbon, humic acids, hydrocarbonic additions, etc.);

cracking of these organic materials;

oxidoreduction reactions between these organic materials and the iron oxides.

The granules obtained are highly resistant.

### SUMMARY OF THE INVENTION

An object of the present invention, in particular, is to remedy the aforementioned disadvantages of the current methods and installations for making expanded clay granules.

According to the invention, this object is achieved due to a method according to which the clay pieces are expanded by subjecting to microwave heating rough pieces obtained by a known and suited preforming process in the shapes and dimensions of the pieces to be manufactured, the term “clay” encompassing all types of clays, in this case, including the transformed clays such as schists and slates.

This expansion method uses the principle of heating dielectric products by means of microwave radiation. This principle is based on the material-radiation interaction that is due to a very high-frequency electromagnetic field (microwaves). The material (clay in this case) in its condensed form, is composed of atoms and molecules called clusters. When subject to an electric field, these clusters are set into a relative motion whose intensity is dependent upon their permittivity. This motion creates frictions between clusters, which cause an internal heating of the product.

Applied to clay pieces such as granules, slabs, sections or the like, the microwave radiation causes a rapid and homogenous heating thereof, the electromagnetic wave directly heating the interior of these pieces. This heating first causes water to vaporize, then generates a gas evolution that causes cell creation and the expansion of clay.

The method according to the invention can be implemented by means of very simple installations that mainly include a very high-frequency electromagnetic energy generator (magnetron), an applicator, and a waveguide.

Furthermore, these installations can be easily adapted so that one can perform the drying of the clay pieces such as granules or balls, slabs, sections, etc., and the heating and expansion of the latter, successively or simultaneously, by means of microwave radiation.

The method according to the invention procures several interesting advantages:

The infrastructures necessary for its implementation can be very light; the space required for the equipment used for this implementation is much less than that of the current rotary furnace heating installations using liquid or gaseous combustibles. Furthermore, since the heat source is due to a targeted excitation of the clay, the operating and maintenance conditions and the equipment are very good.

The efficiency of this method is much greater than that of the heating methods by means of liquid, gaseous, or solid combustibles; a large portion of the power is absorbed by the material (clay granules), such that the heat losses are very small;

The clay is heated in the mass, which minimizes the thermal stresses in the material and the risks for the expanded clay granules to burst, such that the percentage of flawed product is very reduced or practically non-existent;

The rise in temperature of such a microwave oven is very rapid and the expansion is direct, resulting in an absence of inertia (almost immediate availability of the energy);

The drying, curing, and expansion steps can be grouped in a single phase, which allows for saving in time and space.

The method, object of the invention, further procures the following additional advantages, which relate to the use of microwave radiation:

clean method (smokeless, noiseless);

improved security (no burning walls);

possibility of precise control of the heating and expansion parameters and ease of adjustment of the furnace;

high efficiency (55-60%);

increased productivity due to the improved heat diffusion;

correct energy balance;

possibility to make robust and light pieces of large sizes and various shapes out of expanded clay;

economical.

This method offers a great flexibility of use and the possibility to efficiently adjust the technical methods with electric means, by means of rapid and precise automatic systems or by control.

### BRIEF DESCRIPTION OF DRAWINGS

The aforementioned objects, characteristics and advantages, and more, will become more apparent from the description that follows and the annexed drawings, in which:

FIG. 1 is a synoptic diagram of the production of expanded clay granules including a first embodiment of the method according to the invention;

FIG. 2 is a synoptic diagram of the production of expanded clay granules including a second embodiment of the method of the invention;

FIG. 3 is a schematic view of an installation for making expanded clay granules according to the invention.

### DETAILED DESCRIPTION OF THE PREFERRED EMBODIMENTS

Reference is made to the drawings to describe advantageous, non-limiting examples of embodiment of the method for making expanded clay pieces according to the invention.

The manufacture of expanded clay pieces requires clay of all types, as a base material, such as pure clay coming from clay quarry, or clay recycled by upgrading quarry washing mud, or coming from other industries, or transformed clays such as schists or slates. In a known fashion, in the manufacture of expanded clay granules, the granulation of the clay or preparation of granule preforms is possible by grinding, laminating, or extrusion; then, the clay granules are subject to the aforementioned characteristic step of the method according to the invention in order to preferably obtain expanded clay granules having a grain size comprised for example between 0 and 25 mm for an apparent density of 300-630 kg/m³.

If necessary, the clay is brought to the plastic state by incorporating a small quantity of water therein, before laminating or extrusion and, advantageously, one or more additives, for example fuel or furnace additions, can also be incorporated into the clay, making it possible to obtain a plasticity threshold for the clay at a lower temperature. For example, a small quantity of an additive such as fuel is incorporated into the mass of clay, before the granulation or other preforming method, and particularly before the heating step adapted to cause the expansion of the matter, these incorporations being carried out by any known method and equipment.

Before exposure to the microwave radiation, the clay granules or balls thus have a percentage of humidity that can be comprised between 0% and 50%, for example.

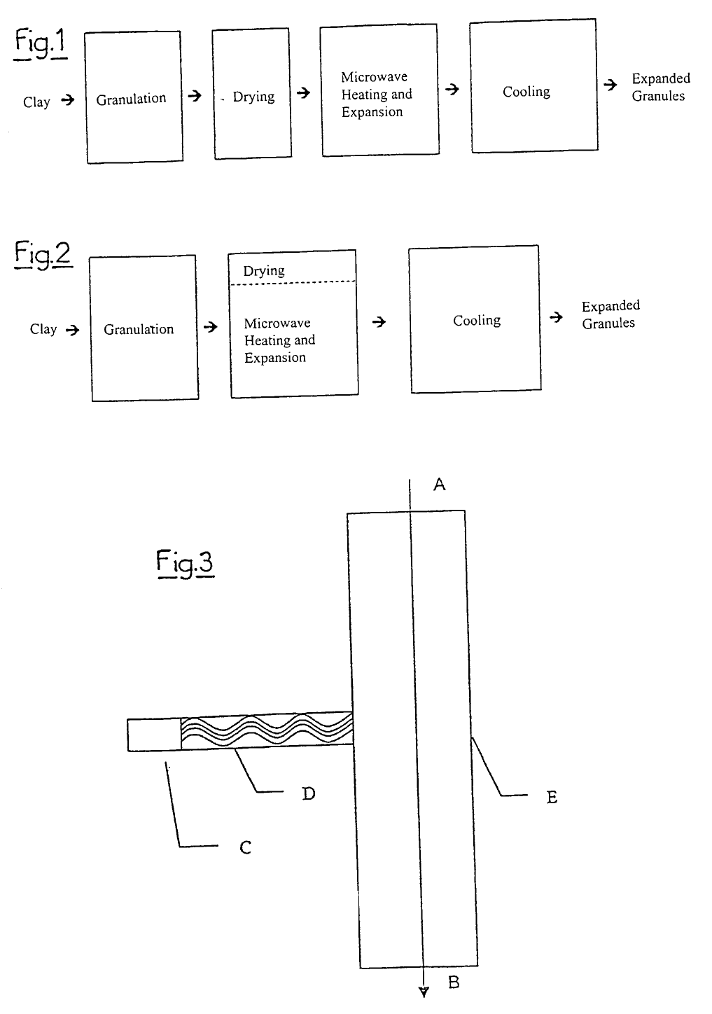

According to a first example of embodiment of the method of the invention (FIG. 1), the preforms of clay granules, after granulation and drying by conventional methods, are introduced into a microwave oven in which the preforms of clay granules are subject to microwave radiation, causing the heating and expansion of the clay. Upon exit from the microwave oven, the expanded clay granules or balls are cooled by passage in a cooling tunnel or in the open air.

In a known manner, they can then be subject to a screening operation before storage or shipping.

The introduction of granule preforms or other clay pieces and their exposure to the effects of microwave radiation can be carried out continuously or in successive batches.

According to a second example of embodiment of the invention (FIG. 2), the clay granule preforms, after granulation, are introduced into a microwave oven in which the clay granules are exposed to microwave radiation, causing the drying, heating and expansion of the clay.

By way of example, the microwave radiation used can be a radiation whose frequency is on the order of 2450 MHz or 915 MHz and the wavelength on the order of 0.1 nm, making it possible to generate temperatures on the order of 1850° C.

The microwave installation used for embodying the method according to the invention (FIG. 3) includes, in a known manner, one or more generators or microwave sources (magnetron) C transforming the electric energy of the network into microwave energy, an applicator E enabling the one by one or continuous microwave heating of the clay granules, and one or more waveguides D transmitting the microwave energy from the generator(s) C to the applicator E.

The applicator E is constituted by a microwave tunnel provided with chambers impervious to microwave leakages at its opposite ends, enabling the input of the clay granules (reference A) and the output of the expanded clay granules (reference B), respectively.

The manufacture of expanded clay pieces other than the balls or granules, such as very long pieces (slabs, sections, etc.) is carried out in a similar manner, the granulation step being replaced by a clay forming or preforming step depending on the pieces to be manufactured.

It is noted that in the case of manufacture of pieces having a constant cross-section, the clay can be preformed by an extruding machine and cut to the desired length upon exit from the extruding machine, or upon exit from the applicator E, the method thus enabling the manufacture of very long pieces, with varied profiles and widths, the length of these pieces capable of being theoretically unlimited.

What is claimed is:

1. Method of making expanded clay pieces, such as granules, slabs, and sections, wherein the clay pieces are expanded by subjecting rough clay pieces obtained by a preforming process to microwave radiation.

2. The method of making expanded clay pieces according to claim 1, wherein the rough clay pieces are dried by a conventional method before being exposed to the microwave radiation ensuring their expansion.

3. The method of making expanded clay pieces according to claim 1, wherein the rough clay pieces are successively or simultaneously dried and heated by exposure to microwave radiation ensuring both their drying and their expansion.

4. The method of making expanded clay pieces according to claim 2, wherein the expansion of the clay pieces is continuously carried out in an applicator (E) constituted by a microwave tunnel.

5. The method of making expanded clay pieces according to claim 3, wherein the drying and expansion of the rough clay pieces are continuously carried out in an applicator (E) constituted by a microwave tunnel.

6. The method of making expanded clay pieces according to claim 2, wherein the expansion of the rough clay pieces is carried out in successive batches in an applicator (E) constituted by a microwave tunnel.

7. The method of making expanded clay pieces according to claim 3, wherein the drying and expansion of the rough clay pieces are carried out in successive batches in an applicator (E) constituted by a microwave tunnel.

8. The method of making expanded clay granules according to any of claim 1, wherein a small quantity of at least one additive is incorporated, making it possible to improve the plasticity of the mass of clay, before preforming the latter.

9. The method according to claim 8, wherein said additive is constituted by a hydrocarbon, such as fuel, for example.

10. Expanded clay pieces, obtained according to the method of claim 1.

11. Expanded clay granules, obtained according to the method of claim 1.

12. Expanded clay slabs, obtained by the method of claim 1.

13. Expanded clay sections, obtained by the method of claim 1.
